(19) United States
(12) Patent Application Publication
(10) Pub. No.: US 2016/0086183 A1
(43) Pub. Date: Mar. 24, 2016

(54) TRUST MANAGEMENT IN TRANSACTION SYSTEMS

(71) Applicant: MasterCard International Incorporated, Purchase, NY (US)

(72) Inventors: David A. Roberts, Warrington (GB); Aaron Smith, Woodley (GB)

(21) Appl. No.: 14/858,304

(22) Filed: Sep. 18, 2015

(30) Foreign Application Priority Data
Sep. 18, 2014 (GB) 1416522.9

(51) Int. Cl. G06Q 20/40; G06Q 20/38

(52) U.S. Cl. CPC G06Q 20/4016; G06Q 20/3829

(57) ABSTRACT

The disclosure provides a method of updating time in a transaction between a transaction device and an offline terminal. Firstly, a transaction is initiated (401) between a transaction device and an offline terminal. A stored trusted time value is then provided and another trusted time value received (402). Each trusted time value exchanged has been affirmed by a trusted time provider. The obtained trusted time value is then compared (404) with the stored trusted time value. The stored trusted time value is replaced (405) with the obtained trusted time value if the obtained trusted time value is more recent than the stored trusted time value. The method may be implemented in a transaction device or a terminal, and methods of risk management in a transaction device and a terminal are also described. Suitably programmed transaction devices and terminals are also described, as is a trusted time provider for a transaction system.

### CROSS-REFERENCE TO RELATED APPLICATION

This application is a U.S. National Stage filing under 35 U.S.C. §119, based on and claiming benefit of and priority to GB Patent Application No. 1416522.9 filed Sep. 18, 2014.

### TECHNICAL FIELD

The present disclosure relates to methods and apparatus for trust management in transaction systems. Embodiments of the present disclosure are particularly appropriate for use where elements of a transaction system are only intermittently in contact with each other.

### BACKGROUND

Trust management in transaction systems, such as those using payment cards as transaction devices, has long been a complex technical issue of great commercial importance. As the subversion of transaction systems by malicious third parties has the potential to compromise significant financial assets, it is very important for all points of potential weakness in a transaction system to be protected by appropriate trust mechanisms. In a transaction system using payment cards or other payment devices, for example using the EMV protocols, as transaction devices, this will require appropriate safeguards for individual cards and devices, for terminals, and for the other elements of the transaction system.

EMV is a financial transaction system based around the use of contact and contactless transaction cards. In the EMV payment model, an issuing bank provides an account holding customer with a smart card (or other token) to use when making payments. An acquiring bank provides a merchant with a compatible terminal device to use when accepting payments. The term “terminal” here is considered to cover any device that interfaces directly with such a transaction card (e.g. an interface allowing user entry of a personal identification number (PIN) such as a PIN pad or PIN Entry Device (PED), or a POS terminal or ATM device comprising means such as these, to allow interaction with a transaction card).

Trust management becomes extremely challenging when some system elements (payment cards and even terminals) are only intermittently in contact with other the main transaction system, and when it may be necessary for one system element to interact with another system element without a full assurance that this further system element is trustworthy. This may apply, for example, in conflict regions or after a natural disaster, or any other circumstance in which normal communication networks such as the wired or wireless telecommunications infrastructure may be wholly or partially disabled.

Transaction systems using the EMV standards will support offline transactions between a payment card or device and a terminal even when the terminal is not in communication with the main transaction system. Such transactions clearly have added risk as the risk management services provided by the main transaction system are not available, and such financial risk cumulates over time and number of transactions. It is strongly preferable to require terminals and payment devices to make an online connection to the main transaction system sufficiently regularly to control this financial risk. This requirement, however, is difficult to achieve for a conventional transaction card. This is because a conventional transaction card does not have a secure and reliable mechanism to track when online connection is required, or to track any other time or event driven metric.

### SUMMARY

In a first aspect, the disclosure provides a method of updating time in a transaction between a transaction device and an offline terminal, comprising: initiating a transaction between a transaction device and an offline terminal; providing a stored trusted time value and receiving an obtained trusted time value, each trusted time value having been affirmed by a trusted time provider; comparing the obtained trusted time value with the stored trusted time value; and replacing the stored trusted time value with the obtained trusted time value if the obtained trusted time value is more recent than the stored trusted time value.

The time propagation mechanism has similarities to that proposed for a different technical purpose in WO 01/09852. This disclosure related to transaction systems adapted for transmission of electronic cash between smart cards. Sequence numbers are signed and provided by a trusted third party to a member of the scheme and communicated to individual smart cards associated with the member when the member is in communication with them. In subsequent transactions between individual smart cards, sequence numbers are exchanged between the smart cards, used for authentication to prevent fraudulent transactions, and updated so that after the transaction both smart cards hold the later sequence number.

The present inventors have appreciated that a similar scheme can be used advantageously in card to terminal transactions in conventional payment card systems such as those using the EMV protocols (the term “payment card” will be used in all further discussion, though it should be understood that other payment devices may be used in an EMV system and other transaction devices may be used in other transaction systems). This allows propagation of a trusted date across an entire estate comprising both payment cards and terminals.

In one embodiment, each trusted time value is affirmed by signature by a private key of an asymmetric key pair, and the method further comprises decrypting the obtained signed trusted time value to determine the obtained trusted time value and to confirm that the obtained trusted time value was validly affirmed by the trusted time provider.

In embodiments, the transaction is performed according to EMV protocols.

In embodiments, the steps are performed by the transaction device, which may be a payment card. Using EMV protocols, the transaction device requests a terminal stored trusted time value using CDOL1.

In a second aspect, the disclosure provides a method of risk management at a transaction device, wherein the transaction device holds a stored date for a risk related action, wherein the transaction device updates a stored trusted time value by the method described above, and wherein the transaction device takes a risk management action if the updated stored trusted time value is later than the stored date by a predetermined period of time. Risk management rules may be updated by a method substantially similar to the method of updating the trusted time value.

In embodiments, the method steps of the first aspect are performed by the terminal. This terminal may be one of a point of sale terminal and an automated teller machine. Using EMV protocols, such a terminal may request a transaction device trusted time value with a GET DATA command, or may provide a terminal trusted time value with a PUT DATA command. The terminal may also request a transaction device trusted time value or provides a terminal trusted time value with a GENERATE AC command.

In a third aspect, the disclosure provides a method of risk management at a terminal, wherein the terminal holds a stored date for a risk related action, wherein the terminal updates a stored trusted time value by the method described above, and wherein the terminal takes a risk management action if the updated stored trusted time value is later than the stored date by a predetermined period of time. The risk management rules may be updated by a method substantially similar to the method of updating the trusted time value.

In a fourth aspect, the disclosure comprises a method of updating time in a transaction between a transaction device and a terminal, comprising the transaction device and the terminal both performing method steps as described above. Preferably, when the terminal is offline the transaction device and the terminal perform these method steps, but wherein the terminal is online and connected to an acquiring bank, the acquiring bank provides a trusted time value to the terminal and to the transaction device.

In a fifth aspect, the disclosure provides a trusted time provider for a transaction system, comprising: a clock providing time values; a public/private key pair, comprising a public key for dissemination throughout the transaction system and a private key for signing time values to provide trusted time values; and a module or other means adapted continually to sample time values from the clock, to sign the sampled time values with the private key to form trusted time values, and to disseminate trusted time values throughout the transaction system.

In a sixth aspect, the disclosure provides a transaction device comprising a memory and a processor, wherein the memory is adapted to store trusted time values, and wherein the processor is programmed to perform the method provided by the first aspect of the disclosure. In embodiments, the transaction device is a payment card.

### BRIEF DESCRIPTION OF FIGURES

Embodiments of the disclosure will now be described, by way of example, with reference to the accompanying Figures, of which:

FIG. 1 shows elements of a payment infrastructure in which embodiments of the disclosure may be used;

FIG. 2 shows in schematic form a transaction card adapted for use in embodiments of the disclosure;

FIG. 3 shows in schematic form a terminal adapted for use in embodiments of the disclosure;

FIG. 4 shows in flow diagram form a method according to a general embodiment of the disclosure;

FIG. 5 shows key interactions and relationships between elements of an EMV transaction system according to an embodiment of the disclosure; and

FIGS. 6A and 6B show alternative implementations of a trusted time value exchange in the course of an offline transaction according to embodiments of the disclosure.

### DESCRIPTION OF SPECIFIC EMBODIMENTS

Specific embodiments of the disclosure will be described below with reference to the Figures. The embodiments described below relate to a payment card used as a transaction device for contactless payments with POI (point of interaction) terminals (such as a POS—point of sale—terminal) under the EMV protocols indicated above. As is discussed further below, further embodiments may be used in other transaction systems and contexts.

A user (not shown) is provided with a payment device in the form of a payment card 1 (as discussed above, in other embodiments other transaction devices may be used). The payment card 1 comprises a chip 3 with a processor and a memory. The chip 3 is here able to contact a terminal 4 to enable contact card protocols such as those defined under ISO/IEC 7816 to be followed. This payment card 1 also has a magnetic stripe 9 to allow a transaction to be carried out using magnetic stripe protocols. The payment card 1 may also comprise an antenna and associated hardware and software to enable communication with a terminal by NFC and associated contactless card protocols such as those defined under ISO/IEC 14443.

Other computer equipment in the infrastructure is typically fixed, such as point of interaction (POI) terminals 4, of which the example shown is a point-of-sale (POS) terminal used by a merchant interacting with the user. The POS terminal 4 interacts with the payment card 1 through a card reader (not shown discretely from POS terminal 4). The merchant POS terminal 4 is connectable to an acquiring bank 6 or other system in a secure way (either through a dedicated channel or through a secure communication mechanism over a public or insecure channel). As discussed below, in embodiments of this disclosure this connection between merchant POS terminal and acquiring bank 6 is intermittent. Through the medium of terminals or otherwise, the payment card 1 may similarly intermittently be put into connection with a card issuing bank 5 or system associated with the user.

A banking infrastructure 7 connects the card issuer 5 and the acquiring bank 6, allowing transactions to be carried out between them. This banking infrastructure will typically be provided by a transaction card provider who provides transaction card services to the card issuing bank 5. The banking infrastructure 7 provides authorization at the time of purchase, clearing of the transaction and reconciliation typically within the same working day, and settlement of payments shortly after that. The banking infrastructure 7 comprises a plurality of switches, servers and databases, and is not described further here as the details of the banking infrastructure used are not necessary for understanding how embodiments of the disclosure function and may be implemented.

Also shown in communication with the banking infrastructure is a trusted time provider 8. This trusted time provider 8 may be the a part of the banking infrastructure 7 or may be a trusted third party—in alternative arrangements, the trusted time provider may be associated with the card issuing bank 5 or the acquiring bank 6, or may communicate with them directly without the involvement of the banking infrastructure. In preferred embodiments, the trusted time provider is an On-Behalf-Of (OBO) service trusted by all parties.

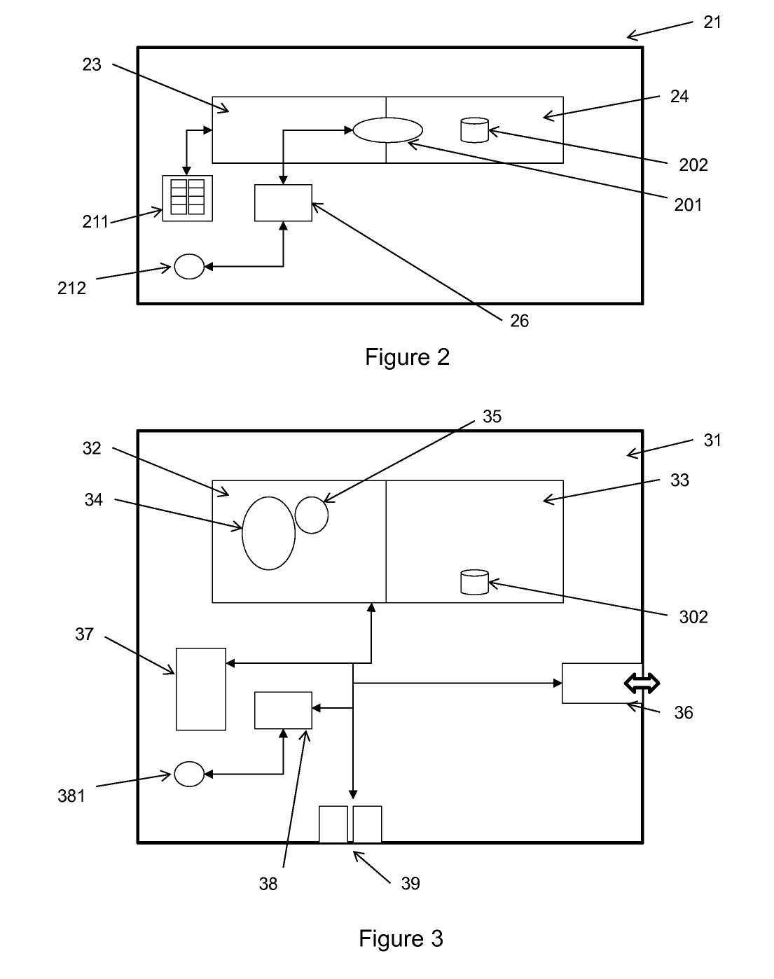

FIG. 2a illustrates the functional features of a payment card 21 for use in embodiments of the disclosure in more detail. As indicated above, embodiments of the disclosure may be used with other payment devices, but there are particular advantages for use of the disclosure with a payment card 21. A payment card 21 is not a convenient form factor to hold a secure clock (it is typically powered down except when interacting with a terminal, and protection against physical tampering is more challenging than for other form factors such as a mobile telephone handset), so the possibility of achieving a counterpart to a secure clock through application of embodiments of the disclosure is of particular value.

FIG. 2 shows schematically relevant parts of a representative hardware and software architecture for a transaction card such as a payment card 21 (particularly an EMV payment card) suitable for implementing an embodiment of the disclosure. The payment card 21 comprises an application processor 23, one or more memories 24 associated with the application processor and a NFC controller 26. The payment card 21 is equipped with a contact pad 211 for contact transactions using contact card protocols such as ISO/IEC 7816 and also comprises an antenna 212 connected to NFC controller 26 to allow transactions under contactless card protocols such as those defined under ISO/IEC 14443.

In the arrangement shown, the application processor 23 and associated memories 24 comprise (shown within the processor space, but with code and data stored within the memories) a transaction application 201. The memories 24 contain a storage location 202 for a trusted time value. The application processor 23 provides an NFC application 207 which interfaces with the NFC controller 26. A transaction may be performed over a contact card interface, a contactless card interface, or any other communication channel available to the card for communicating with a terminal (either general purpose or dedicated to the purpose).

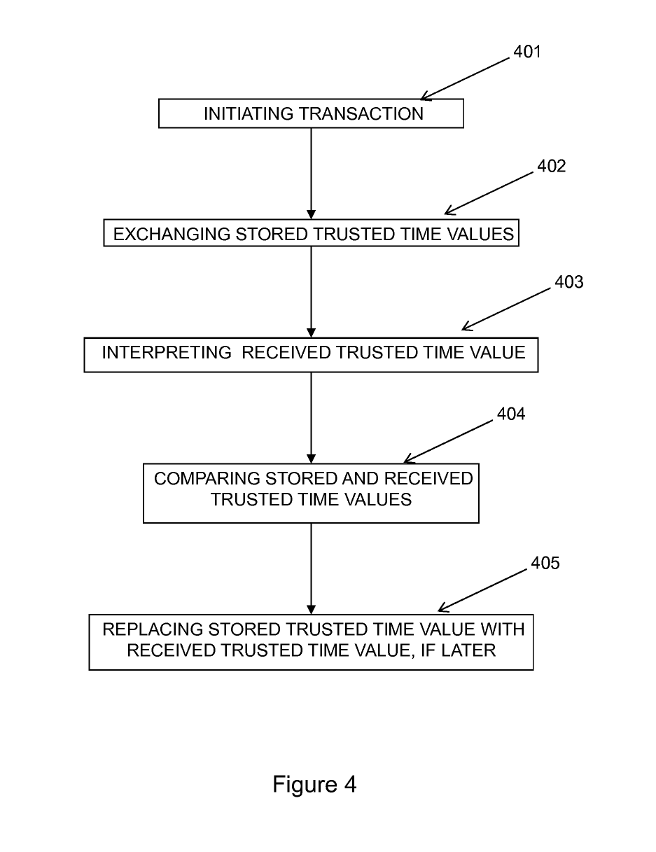

FIG. 3 illustrates the functional features of a terminal for use in embodiments of the disclosure in more detail. The terminal 31 has a processor 32 and associated memories 33. The base function of the terminal in the case shown is to operate as a point of interaction (P01) with a financial system—such a terminal may be a point of sale (POS) terminal or an automated teller machine (ATM) for example. In other embodiments, the terminal may have another function altogether (for example, a security system terminal for evaluating user credentials). In the case shown, the terminal 31 has an operating system 34 and transaction software 35 (these may be provided together in a single assemblage of code, or may both be divided into a number of different components, but are represented here as two elements for convenience). The operating system 34 manages hardware resources and provides common services for applications, whereas the transaction software 35 performs the base function of the terminal and may be provided (for example) as one or more applications. The terminal 31 will generally have a protected channel 36 to another party such as an acquiring bank (this may, for example, be effected over a public network by use of encryption)—embodiments of the disclosure have particular value in situations where this protected channel 36 is only sporadically available to the terminal 31. The terminal 31 will also have means to make a connection to a device such as a transaction card. In this case, the terminal has a contact card reader 37 and an NFC controller 38 and antenna 381 to allow a contactless card connection to a contactless card, or a device such as an NFC-enabled mobile telephone able to act as a proxy for a contactless card. The terminal 31 may have additional ports 39 to allow data to be provided to it from other sources (for example, by USB stick). The memories 33 contain a storage location 302 for a trusted time value. Transactions may be established through the contact card reader 37 or through the NFC controller 38, or indeed any other appropriate local connection.

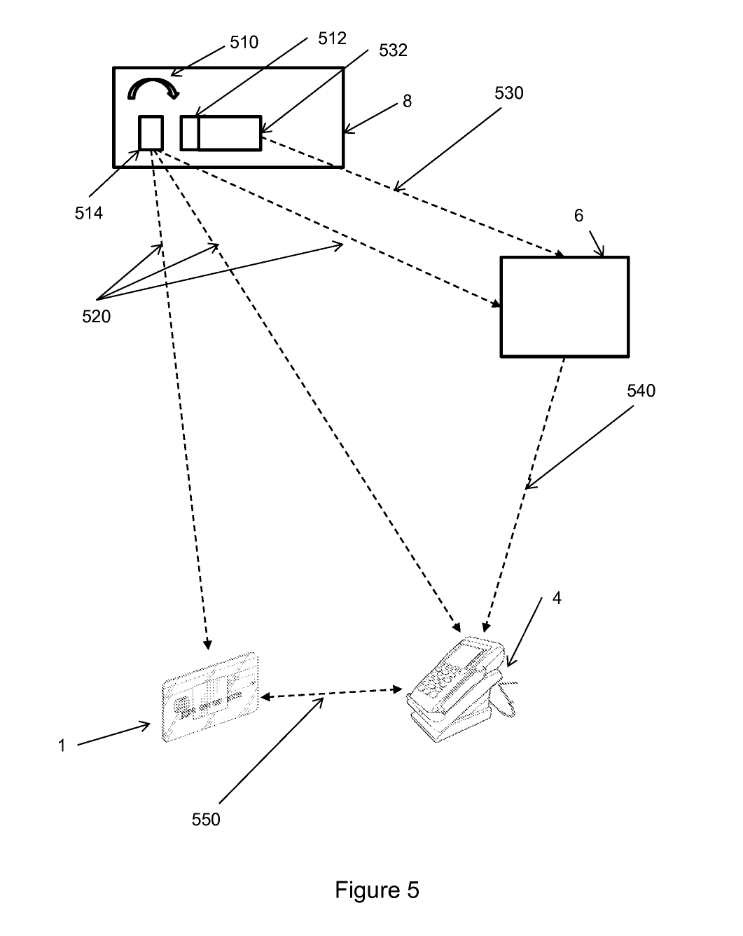

FIG. 4 shows in flow diagram form a method according to a general embodiment of the disclosure. The method steps shown relate to a method of updating a trusted time value held in a transaction device (such as a transaction card) and a terminal. These method steps will typically be followed when the terminal is offline, as an online connection would typically be used for preference to update trusted time directly from an online source of trusted time if an online connection were available. The method steps shown may be carried out either by the transaction device or by the terminal.

First of all, a transaction is initiated (step 401) between the transaction device and the terminal. The following steps may in some arrangements be carried out only if the transaction is an offline transaction, with a different approach—for example, involving both transaction device and terminal receiving a current trusted time value directly from a trusted time source—being taken if an online connection is available.

In connection with the transaction, trusted time values stored by the transaction device and the terminal are exchanged (step 402). This will typically take place during the transaction, for example by adding commands to the transaction protocol or by repurposing additional commands as is discussed further below. In other embodiments, the trusted time value exchange may take place before or after the transaction itself. For the time value to be trusted, it needs to be demonstrably trustworthy, typically by being vouched for in an effective way by a trusted entity. A preferred way to do this is for a trusted time provider to sign time values with its private key, the signed values then being used as trusted time values.

Each party then interprets its received trusted time value (step 403) in order to resolve a time. Where the received trusted time value has been encrypted with the private key of a trusted time provider, this interpretation will involve decryption of the received trusted time value using the public key of the trusted time provider, which will have been provided to all parties in the system at an earlier stage to ensure that it can be used in connection with offline transactions.

Each party then compares the received trusted time value with its stored trusted time value (step 404) to determine which is later. If the values are not the same (which is possible), then this will involve one party of the two parties to the transaction having a received trusted time value later than its stored trusted time value. This party will then replace its stored trusted time value with the received trusted time value (step 405) as the received trusted time value is more recent. Both parties then end the transaction with a “time” equal to the later of the two trusted time values held by the parties prior to the transaction.

A further embodiment relating to a payment card using EMV protocols will now be described in more detail. Payment cards are pervasive and are for many users the primary means for making a purchase or other financial transaction. Such users are often not effectively prepared for situations in which payment cards cannot be used effectively. EMV protocols allow for offline transactions, so payment cards can be used in environments where communications may intermittently fail. However, where communications are generally unreliable and both cards and terminals are generally offline, it is challenging to operate under EMV protocols in a conventional way with effective risk management. Some remote communications environments may fall generally into this type, but a greater practical problem is that of maintaining a financial infrastructure in a war zone or after a natural disaster. A practical problem is that a payment card will generally need to go online periodically—both to top up an offline balance but also to ensure that risks are managed effectively—but conventional EMV processes do not allow a payment card to assess this, as a payment card lacks a trusted clock.

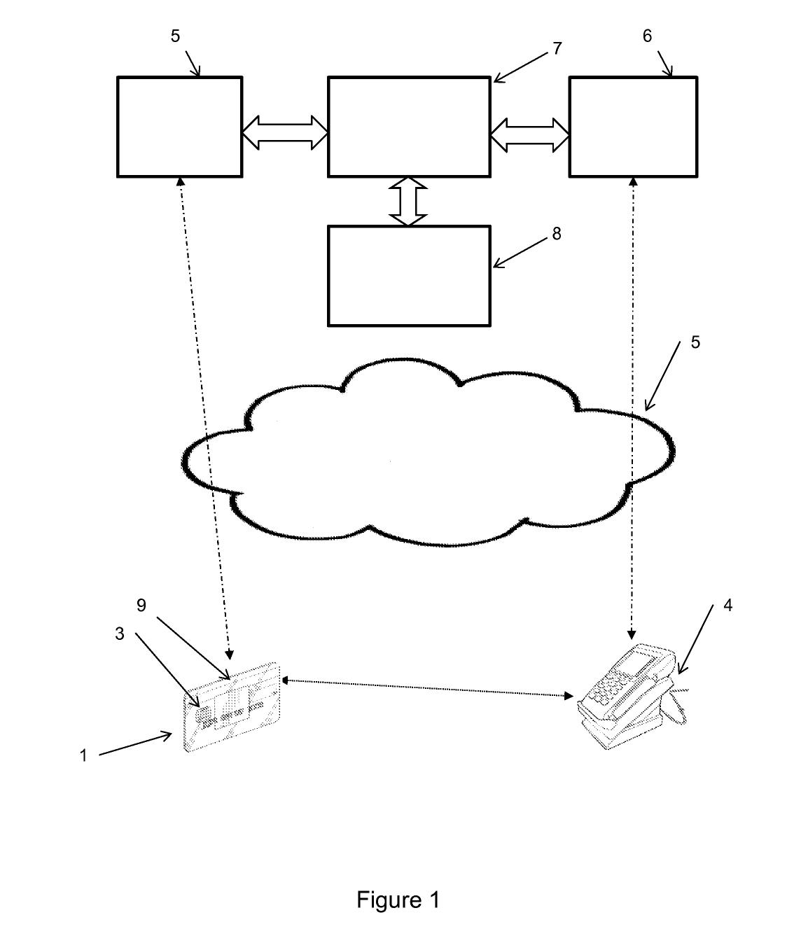

The transaction system remains generally as shown in FIG. 1. For the system to operate, terminals 4 must go online at sporadic intervals at least in order to furnish transaction data, but these intervals may be infrequent and unpredictable. Moreover, given the difficulty of a commercial operation in such environments it should be assumed that terminals 4 themselves cannot safely be trusted by a payment card 1. A payment card 1 will trust its own card issuer 5, but it may trust another party such as an On-Behalf Of (OBO) service. In the transaction system shown in FIG. 1, this OBO service is (or is associated by a sufficient trust relationship with) the trusted time provider 8.

A payment card 1 itself does not comprise a trusted clock. Terminals 4 will generally have clocks, but if a terminal 4 cannot be trusted the clock of a terminal 4 typically cannot be trusted either. A payment card 1 will exchange information with a terminal 4 during an offline transaction, but while the payment card 1 may obtain a time value from the clock of the terminal 4, the payment card 1 cannot safely rely on this time value.

In embodiments of the disclosure, the OBO service is used as a trusted time provider to provide trusted time values which are propagated virally—without loss of trust—over potentially the whole of transaction system, offline transaction by offline transaction. The model for propagation of time resembles that proposed in WO 01/09852, a technical disclosure related to transaction systems adapted for transmission of electronic cash between smart cards. In that approach, sequence numbers are signed and provided by a trusted third party to a member of the scheme and communicated to individual smart cards associated with the member when the member is in communication with them. In subsequent transactions between individual smart cards, sequence numbers are exchanged between the smart cards, used for authentication to prevent fraudulent transactions, and updated so that after the transaction both smart cards hold the later sequence number.

In embodiments of the disclosure, the problem to be addressed is somewhat different from that addressed in WO 01/09852 and the nature of the trusted time values and of their use is also somewhat different. The OBO service provides a public private key pair, retaining the private key and distributing the public key freely to all payment cards and terminals. The OBO service possesses a clock which can be generally trusted throughout the transaction system, as the OBO service is itself trusted. The OBO service signs dates regularly with its private key and provides them as trusted time values throughout the online part of the transaction system—in particular, the acquiring bank 6 will be provided with these trusted time values regularly, and so will be able to provide a latest trusted time value to a terminal 4 when it interacts with that terminal.

When the acquiring bank 6 interacts with a terminal 4 when it is online (for example, to upload transaction data), it will provide its latest trusted time value to the terminal 4—if the terminal 4 is carrying out an online transaction, a payment card 1 may also receive this trusted time value with the transaction data. The terminal 4 will determine the date corresponding to the trusted time value by decrypting it with the OBO service public key, and will store the trusted time value as its stored “latest” date.

Generally, a payment card 1 will request a trusted time value during a transaction with a terminal 4, and the terminal 4 will request a trusted time value from the payment card 1. If the transaction is online, the trusted time value may be obtained directly from the acquiring bank 6 as indicated above, but if the transaction is offline, in each of the payment card 1 and the terminal 4 the stored trusted time value obtained at the last online connection between that element and the acquiring bank 6 should be used (unless this trusted time value has been replaced by a later trusted time value obtained in a transaction, as discussed below). Payment cards 1 and terminals 4 update their current stored signed date (trusted time value) if they receive from the other a correctly signed date that is more recent than the one that they already have stored.

The benefit of this viral model is that because cards transact at multiple terminals, even when most cards and some terminals do not frequently go online, the date will propagate across the whole estate quickly by cards distributing it to terminals and terminals distributing it to cards.

While an OBO service may be used to provide trusted time throughout a whole transaction system estate indefinitely, an OBO service may be appointed to operate for a period of time. For example, during a period of local emergency an appropriate OBO service—for example a government or an intergovernmental aid agency—may operate to provide trusted time. It may be, for example, that the necessary steps are taken to provide trusted time in advance (appointment of a trusted time provider and dissemination of its public key) but the trusted time provision activated only when the online connection became sporadic rather than general.

As, using this model, there is now a reasonable expectation that the trusted time value at a transaction card is a recent value, the trusted time value may be used for card risk management. Requirements may then be placed on a card—such as topping up an offline balance after a 30 day period when first possible to do so, or for function to be inhibited (e.g. the card may stop working or only work online, or may operate in a lower risk mode in which larger value or otherwise riskier transactions are prevented). This may operate similarly for a terminal—terminals may have inhibited function until next online connection if the terminal can establish that it has been offline for more than a predetermined period of time.

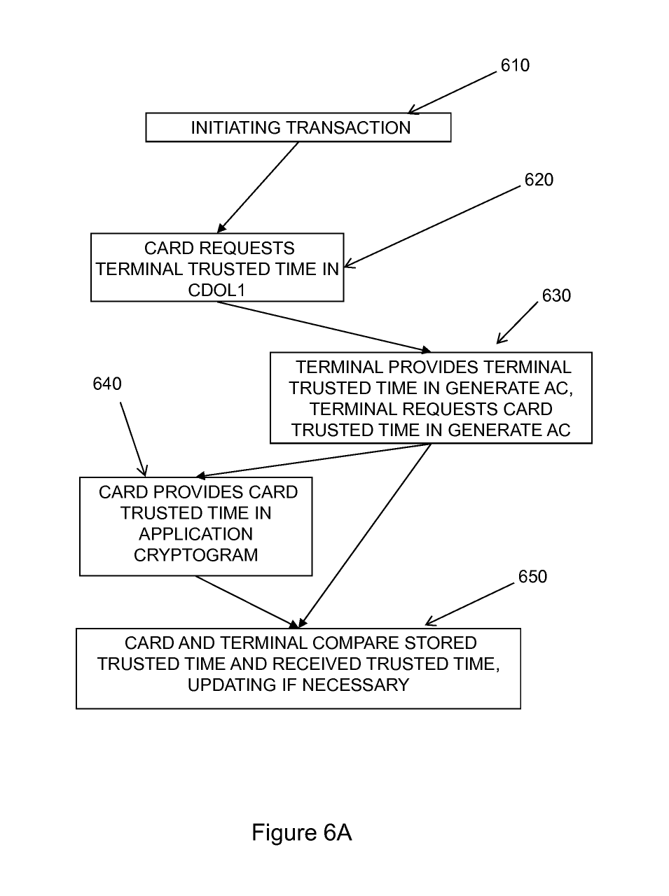

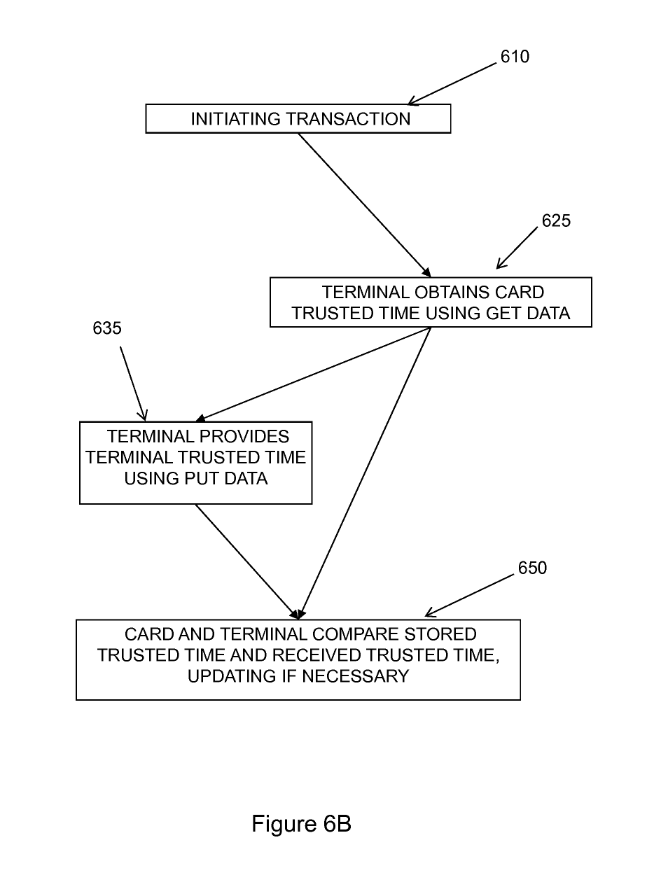

Implementation of this arrangement will now be described in more detail with reference to FIGS. 5 and 6.

FIG. 5 shows key interactions and relationships between a payment card 1, a terminal 4, the terminal's acquiring bank 6 and the OBO service 8 providing trusted time.

The first interaction shown is the generation 510 of a private/public key pair by the OBO service 8. This may be by any suitable asymmetric algorithm or technique, such as ECC or RSA, with a level of security appropriate to the risk of loss were the trusted time process to be subverted. The private key 512 is then held within the OBO service 8, and the public key 514 disseminated 520 throughout the payment infrastructure, including to the payment card 1, the terminal 4 and the terminal's acquiring bank 6.

With a predetermined frequency appropriate to its use, the OBO service 8 then signs a current date from its clock 532 and distributes 530 the signed date to each acquiring bank 6 as a trusted time value. The signature may be by any technique appropriate to the type of key used (for example, EC-DSA or EC-Schnorr may be used if ECC is used to generate the original key pair). The latest signed date held by the acquiring bank 6 is then forwarded 540 to the terminal 4 when the terminal is next online. If this is during the course of a transaction between the terminal 4 and a payment card 1, the latest signed date may be provided to the payment card 1 also as a part of that transaction. In subsequent offline transactions, there will be an exchange 550 of trusted time values between the payment card 1 and the terminal as described further below with reference to FIG. 6.

FIGS. 6A and 6B illustrates schematically steps of a trusted time value exchange between a payment card 1 and a terminal 4 in the course of an offline transaction. In principle, the same steps could be followed in an online transaction, in which case both the payment card 1 and the terminal 4 can be provisioned with the most recent signed date provided by the acquiring bank 6 to the terminal 4. These steps are integrated within an EMV transaction flow, for which the definitive references are the EMV specifications, which may be found at http://www.emvco.com/specifications.aspx.

According to the EMV transaction flow, once the transaction has been initiated 610 with selection of an application and determination of authentication and processing options, the card provides specified records 620 to the terminal including the Card Risk Management Data Object List 1 (CDOL1) following the GPO (Get Processing Options) command. CDOL1 includes various data that is to be provided by the terminal to the card in a first subsequent GENERATE AC command (as described below). In certain embodiments of the disclosure, CDOL1 comprises a request for the latest trusted time value held by the terminal.

After PIN verification, the terminal sends a GENERATE AC command 630 when a decision has been made on the status of the transaction—different commands are defined under the EMV protocols depending on the decision, but each requests a particular Application Cryptogram from the card. In embodiments of the disclosure, the GENERATE AC command is overloaded with the latest signed date requested by the card from the terminal. The GENERATE AC command (or a subsequent such command—there may be multiple GENERATE AC commands in a transaction) may also in embodiments of the disclosure contain a request for the card to provide its latest signed date to the terminal. The card then provides an Application Cryptogram (either as requested or of a different type if the transaction is rejected by the card) 640, and this in appropriate embodiments of the disclosure may contain the latest signed date held by the card and requested by the terminal. The card 1 and the terminal 4 then each compare (and if the signature is determined to be valid using the OBO service public key and the date is determined to be more recent, replace) 650 stored and received trusted time values using the approach set out above.

FIG. 6B illustrates an alternative approach in which GET DATA and PUT DATA commands are used instead of providing the trusted time exchange inline in the transaction by overloading GPO and GENERATE AC. GET DATA and PUT DATA are commands that do not provide a defined part of the transaction flow, but which may instead be used to transmit information between the card 1 and the terminal 4—GET DATA may be used for the terminal to obtain data from the card, and PUT DATA may be used to update fields in the card. Here in step 625 a GET DATA command is used to obtain the stored trusted time value from the card for storage in a received trusted time value field in the terminal for subsequent comparison, and in step 635 a PUT DATA command is used to update a received trusted time value field in the field for a subsequent comparison.

The arrangements of FIG. 6A and FIG. 6B could readily be combined where convenient—for example, the card may request the trusted time value from the terminal using CDOL1, but the terminal may request the trusted time value from the card using GET DATA.

The processes described may be extended to take advantage of the trust relationship between the OBO service and the different elements of the transaction system by disseminating updated risk management rules by the same process as is used to disseminate trusted time values. One approach may be to include a further field in a trusted time value exchange to indicate a latest rules date. If the card or the terminal determines that its stored date was earlier than the latest rules date, it may then request the signed rules update from the other. Dissemination of risk management rules (or other information that it is desirable to share across the transaction estate) could take place as a separate process, without being dependent on propagation of the trusted time values, or could be associated with propagation of trusted time values.

Updating of rules in this way can be particularly beneficial with certain form factors of transaction device. For example, if a transaction device is implemented as a sticker (as may be the case with RFID and NFC implementations), then a requirement for an online connection to an issuing bank (say) may be challenging, whereas an update propagated through the transaction estate may be straightforward.

Both the card 1 and the terminal 4 are then able to use the trusted date in risk management. For example, the card may determine that if the difference between a current trusted date and a stored date (for example, the date of a last online transaction) is too great, a card bit may be set to prevent further offline transactions but allow online transactions (for example, this may involve setting a CVR (Cardholder Verification Rule) bit). Similarly, if the difference between a current trusted date and a stored date exceeds a threshold, the card may be required to update the offline balance by a specified amount. In both cases the stored date can then be updated when the necessary action has taken place. Terminal actions may be conditioned in a similar way—for example, if the difference between a current trusted date and a stored date of a last online transaction is too great, the terminal may be required to go online before it can transact or its transaction capabilities may be limited.

As the person skilled in the art will appreciate, further embodiments may be devised according to the spirit and scope of the disclosure as set out above.

1. A method of updating time in a transaction between a transaction device and an offline terminal, comprising:
initiating a transaction between a transaction device and an offline terminal;
providing a stored trusted time value and receiving an obtained trusted time value, each trusted time value having been affirmed by a trusted time provider;
comparing the obtained trusted time value with the stored trusted time value; and
replacing the stored trusted time value with the obtained trusted time value if the obtained trusted time value is more recent than the stored trusted time value.

2. A method as claimed in claim 1, wherein each trusted time value is affirmed by signature by a private key of an asymmetric key pair, and further comprising decrypting the obtained signed trusted time value to determine the obtained trusted time value and to confirm that the obtained trusted time value was validly affirmed by the trusted time provider.

3. A method as claimed in claim 1, wherein the transaction is performed according to EMV protocols.

4. A method as claimed in claim 1, wherein the method steps are performed by the transaction device.

5. A method as claimed in claim 4, wherein the transaction device is a payment card.

6. A method as claimed in claim 4 wherein the transaction is performed according to EMV protocols and wherein the transaction device requests a terminal stored trusted time value using CDOL1.

7. A method of risk management at a transaction device, wherein the transaction device holds a stored date for a risk related action, wherein the transaction device updates a stored trusted time value by the method of claim 1, and wherein the transaction device takes a risk management action if the updated stored trusted time value is later than the stored date by a predetermined period of time.

8. A method of risk management as claimed in claim 7, wherein risk management rules are updated by a method substantially similar to the method of updating the trusted time value.

9. A method as claimed in claim 1, wherein the method steps are performed by the offline terminal.

10. A method as claimed in claim 9, wherein the terminal is one of a point of sale terminal and an automated teller machine.

11. A method as claimed in claim 9 wherein the transaction is performed according to EMV protocols and wherein the terminal requests a transaction device trusted time value with a GET DATA command.

12. A method as claimed in claim 9 wherein the transaction is performed according to EMV protocols and wherein the terminal provides a terminal trusted time value with a PUT DATA command.

13. A method as claimed in claim 9 wherein the transaction is performed according to EMV protocols and wherein the terminal requests a transaction device trusted time value or provides a terminal trusted time value with a GENERATE AC command.

14. A method as claimed in claim 9, wherein the terminal holds a stored date for a risk related action and updates a stored trusted time value and performs a risk management action if the updated stored trusted time value is later than the stored date by a predetermined period of time.

15. A method of risk management as claimed in claim 14, wherein risk management rules are updated by a method substantially similar to the method of updating the trusted time value.

16. A method as claimed in claim 1, wherein at least one method step is performed at least partly by the offline terminal and at least one method step is performed at least partly by the transaction device.

17. A method of updating time in a transaction between a transaction device and a terminal, wherein when the terminal is offline the transaction device and the terminal perform the method of claim 16, but wherein the terminal is online and connected to an acquiring bank, the acquiring bank provides a trusted time value to the terminal and to the transaction device.

18. A trusted time provider for a transaction system, comprising:
a clock providing time values;
a public/private key pair, comprising a public key for dissemination throughout the transaction system and a private key for signing time values to provide trusted time values; and
a module adapted continually to sample time values from the clock, to sign the sampled time values with the private key to form trusted time values, and to disseminate trusted time values throughout the transaction system.

19. A transaction device comprising a memory and a processor, wherein the memory is adapted to store trusted time values, and wherein the processor is programmed to initiate a transaction between the transaction device and an offline terminal; provide a stored trusted time value and receive an obtained trusted time value, each trusted time value having been affirmed by a trusted time provider; compare the obtained trusted time value with the stored trusted time value; and replace the stored trusted time value with the obtained trusted time value if the obtained trusted time value is more recent than the stored trusted time value.

20. A transaction device as claimed in claim 19, wherein the transaction device is a payment card.
